(19) United States
(12) Patent Application Publication
(10) Pub. No.: US 2016/0283338 A1
(43) Pub. Date: Sep. 29, 2016

(54) BOOT OPERATIONS IN MEMORY DEVICES

(71) Applicant: Intel Corporation, Santa Clara, CA (US)

(72) Inventor: Anand S. Ramalingam, Beaverton, OR (US)

(73) Assignee: Intel Corporation, Santa Clara, CA (US)

(21) Appl. No.: 14/670,705

(22) Filed: Mar. 27, 2015

(51) Int. Cl. G06F 11/22; G06F 11/14; G06F 9/44

(52) U.S. Cl. CPC G06F 11/2284; G06F 9/4411; G06F 9/442; G06F 11/1441

(57) ABSTRACT

Apparatus, systems, and methods to implement boot operations in nonvolatile storage devices are described. In one example, a controller comprises logic to receive a shutdown notification from a host device operating system, monitor modifications to one or more an indirection table segments for the nonvolatile memory during a shutdown process, and mark the one or more indirection table segments which were modified during the shutdown for fast loading during a subsequent boot process for the host device. Other examples are also disclosed and claimed.

### FIELD

The present disclosure generally relates to the field of electronics. More particularly, aspects generally relate to boot operations in storage devices.

### BACKGROUND

Solid state drives (SSD) provide high speed, nonvolatile memory capacity without the need for moving parts. A SSD commonly includes an indirection table to map logical block addresses (LBAs) to physical block addresses (PBAs) on the media. A conventional SSD, when powered on, implements a process to update the indirection table. Because the indirection table is relatively large, e.g., 1 Mega Byte for each Giga Byte of storage capacity in the SSD, updating the indirection table can be a time consuming process, in part because the entire contents of the table that was written since the last snapshot of the table must be read in the order it was written. Further, most SSDs cannot respond to input/output (I/O) requests until the indirection table is updated.

Accordingly, techniques to manage boot operations storage devices may find utility, e.g., in memory systems for electronic devices.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 is a schematic, block diagram illustration of components of an apparatus in which boot operations in storage devices may be implemented in accordance with various examples discussed herein.

FIG. 2 is a schematic, block diagram illustration of boot operations in storage devices that may be implemented in accordance with various examples discussed herein.

FIG. 3A is a schematic illustration of an indirection table in a memory in accordance with various examples discussed herein.

FIG. 3B is a schematic, block diagram illustration of boot processes in storage devices may be implemented in accordance with various examples discussed herein.

FIG. 4 is a schematic, block diagram illustration of boot operations in storage devices may be implemented in accordance with various examples discussed herein.

FIG. 5 is a schematic illustration of boot operations in storage devices may be implemented in accordance with various examples discussed herein.

FIGS. 6-10 are schematic, block diagram illustrations of electronic devices which may be adapted to implement boot operations in storage devices may be implemented in accordance with various examples discussed herein.

### DETAILED DESCRIPTION

In the following description, numerous specific details are set forth in order to provide a thorough understanding of various examples. However, various examples may be practiced without the specific details. In other instances, well-known methods, procedures, components, and circuits have not been described in detail so as not to obscure the particular examples. Further, various aspects of examples may be performed using various means, such as integrated semiconductor circuits (“hardware”), computer-readable instructions organized into one or more programs (“software”), or some combination of hardware and software. For the purposes of this disclosure reference to “logic” shall mean either hardware, software, or some combination thereof.

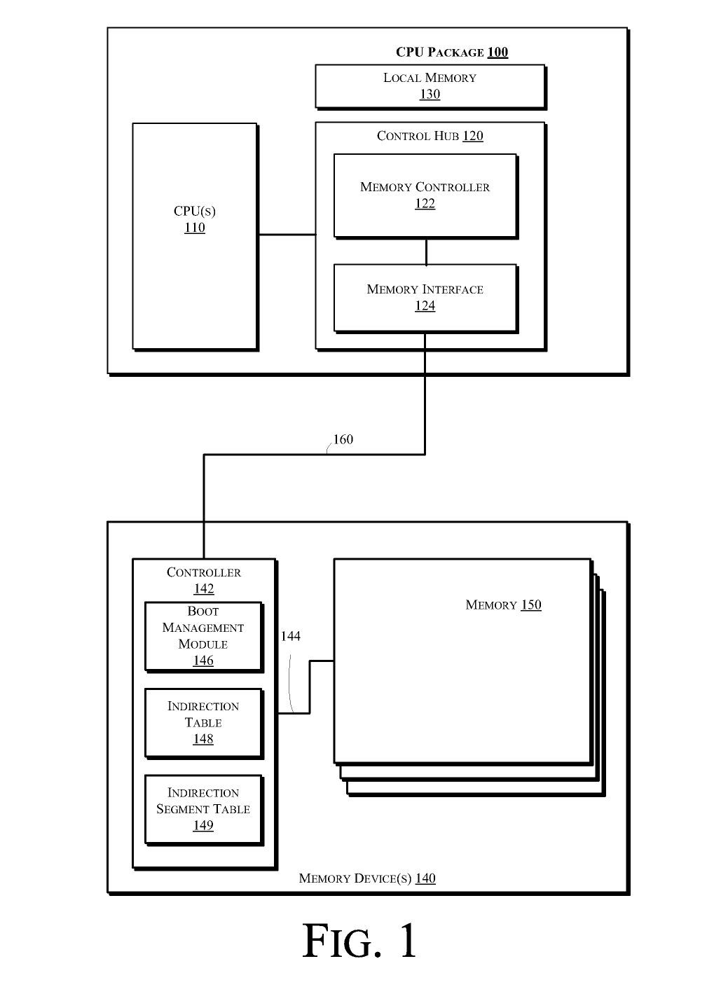

Techniques to speed up the boot process of a storage device, such as a SSD, which incorporate an indirection table are described in detail below. In brief, a storage device may use one or more heuristics to detect different boot sequences and shutdown sequences for a host electronic device. During a shutdown sequence a storage device may mark the one or more indirection table segments which were modified during the shutdown for fast loading during a subsequent boot process for the electronic device. During a pre-boot mode the storage device may allow read operations to at least one predetermined logical block address while the indirection table is being initialized. During a boot sequence the storage device may load one or more indirection table segments which were marked during the shutdown for fast loading during a subsequent boot process for the electronic device. Specific details of a systems and methods to manage read devices in electronic devices will be described below with reference to FIGS. 1-10.

FIG. 1 is a schematic, block diagram illustration of components of an apparatus in which methods to manage a storage device may be implemented in accordance with various examples discussed herein. Referring to FIG. 1, in some examples a central processing unit (CPU) package 100 which may comprise one or more CPUs 110 coupled to a control hub 120 and a local memory 130. Control hub 120 comprises a memory controller 122 and a memory interface 124. In some examples the control hub 120 may be integrated with the processor(s) 110.

Memory interface 124 is coupled to one or more remote storage devices 140 by a communication bus 160. Storage device 140 may be implemented as a solid state drive (SSD), a nonvolatile direct in-line memory module (NV-DIMM) or the like and comprise a controller 142 and memory 150. In various examples, at least some of the memory 150 may comprise nonvolatile memory, e.g., phase change memory, NAND (flash) memory, ferroelectric random-access memory (FeTRAM), nanowire-based non-volatile memory, memory that incorporates memristor technology, a static random access memory (SRAM), three dimensional cross-point memory, spin-transfer torque memory (STT-RAM) or NAND memory. The specific configuration of the memory 150 in the memory device(s) 140 is not critical. In such embodiments the memory interface may comprise an interface compatible with the Serial Advanced Technology Attachment (SATA) specification(s) publicly accessible on the SATA website at www.serialata.org, a PCI Express (PCIE) to 100 interface, a nonvolatile media express (NVMe) interface, or the like.

Controller 142 may comprise logic, at least partially including hardware logic, defining a boot management module 146. Further, controller 142 may maintain a maintain an indirection table 148 which may comprise an array which maps a logical address received with a read request to a physical address in the nonvolatile memory.

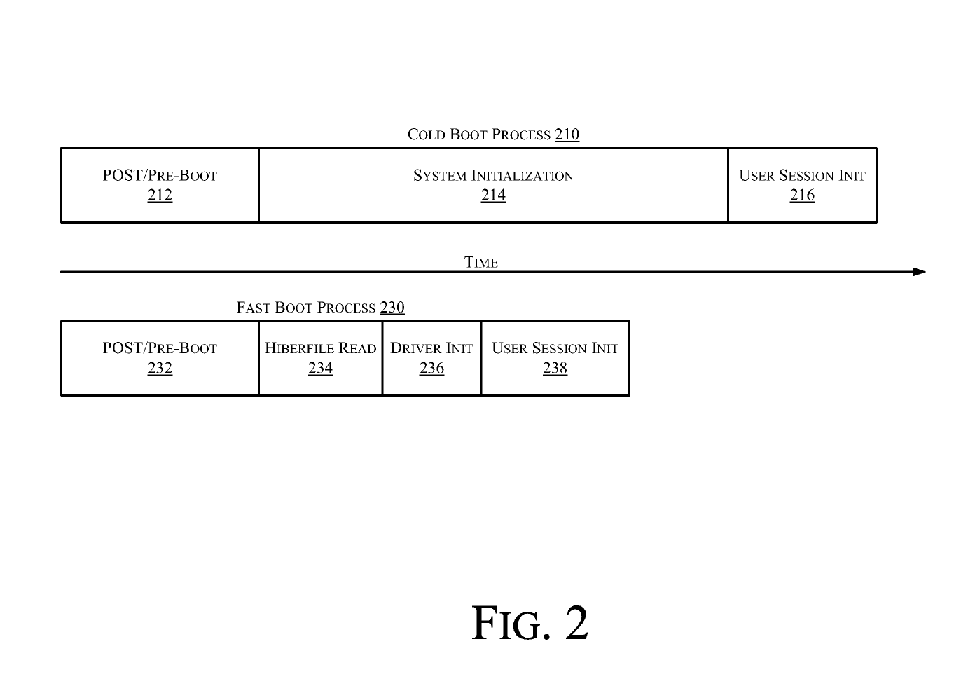

In some examples, controller 142 may further comprise an indirection segment table 149 with 4096 entries. The indirection segment table breaks the indirection table memory into 4096 equally sized chunks and includes a pointer to the physical NAND address that contains the content of the indirection segment. Each entry in the indirection segment table also includes attribute to describe if the indirection segment content is dirty (i.e., on power loss, a power-loss recovery (PLR) algorithm is necessary to reconstruct the indirection memory) or clean (i.e., the indirection table stored in the NAND memory is coherent. On reboot/power-up, the content can be directly loaded to memory without PLR.). During normal shutdown operations, the indirection segment table 149 is saved along with indirection content representing a boot access sequence. During boot operations, clean segments are loaded to memory in a predetermined sequence enabling media read access to LBAs from clean segments. FIG. 2 is a schematic, block diagram illustration of boot operations in storage devices that may be implemented in accordance with various examples discussed herein. Referring to FIG. 2, in some examples a cold boot process may comprise a power-on self-test (POST) preboot operation 212, a system initialization process 214, and a user session initialization process 216. By contrast, in a fast boot process, for example in an electronic device which utilizes the Microsoft® Windows® operating system may include a power-on self-test (POST) preboot operation 232, a hiber file read process 234, a driver initialization process 236, and a user session initialization process 238.

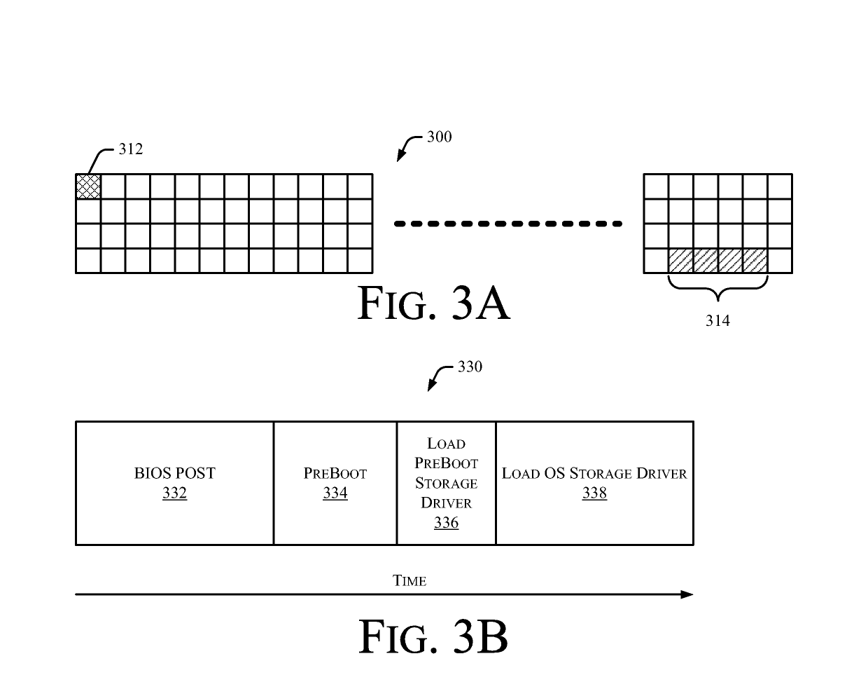

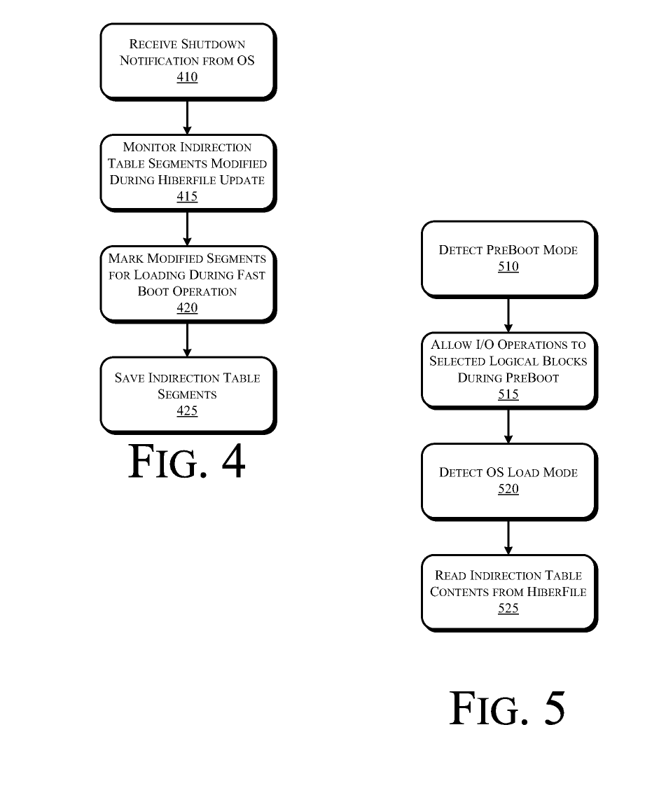

Operations implemented by controller 142 will be described with reference to FIGS. 3A and 3B and 4-5. Referring to FIG. 4, at operation 410 the controller 142 receives a read shutdown notification from a host device operating system. In some examples the host device may comprise an electronic device which utilizes a Windows® operating system. In such examples the operating system sends a shutdown notification to the memory device(s) 140, which is detected by controller 142.

At operation 415, in response to the shutdown notification the controller 142 monitors modifications to the indirection table during the shutdown process, and at operation 420 the controller 142 marks one or more indirection table segments which were modified during the shutdown process for fast loading during a subsequent boot process. Referring briefly to FIG. 3A, in some examples the indirection table 300 may be represented as an array of segments comprising indirection content. The first segment 312 may be assigned the indirection content associated with LBA0 through LBA63. By way of example, if the segments indicated by reference numeral 314 were modified during the shutdown process then the segments 314 may be marked for fast loading, as indicated by the shading associated with these segments.

At operation 425 the contents of the indirection table segments are saved. In examples in which the host device utilizes a Windows® operating system the indirection table segments may be saved in the hiberfile. A typical hiberfile saved during shutdown includes approximately 800 MB, which requires approximately 1 MB of indirection content to be saved during the shutdown sequence. At typical NAND write bandwidth of 1 Gigabyte Per Second (GBPS), this operation adds approximately a few milliseconds of time to the shutdown sequence. Further, in some examples the first indirection segment 312 is also saved to accelerate the pre-boot sequence. The host device may then complete the shutdown process.

Operations implemented during an accelerated boot process will be described with reference to FIG. 5 and FIG. 3B. FIG. 5 is a flowchart illustrating operations implemented by controller 142 during an accelerated boot process, and FIG. 3B is a schematic, block diagram illustration of boot processes in storage devices may be implemented in accordance with various examples discussed herein. Referring first to FIG. 3B in some examples a boot process 330 begins with a basic input/output system (BIOS) power-on self-test (POST) process 332 then transitions to a preboot process 334. Referring to FIG. 5, at operation 510 controller 142 detects when a host device is entering a preboot mode. In some examples, when the host device powers on the controller 142 on a cold boot, the detects a cold boot power up. The cold boot detection indicates to the controller 142 that the host device is in pre-boot mode.

At operation 515, in response to the host electronic device entering a preboot mode, the controller 142 allows input/output (I/O) operations to selected logical blocks during the preboot process. For example, in the preboot mode, the first media access request is a read of LBA0. Since LBA 0-63 were saved at operation 420, the controller 142 discovers the physical locations containing the data for LBA0-63 within the first 100 milliseconds of the controller 142 powering on. The controller 142 may therefore allow I/O requests to access to LBA locations 0-63 using a preboot driver 336 even before the rest of the indirection table is fully initialized.

At operation 520 the controller 142 detects that the host electronic device has entered an operating system load mode, e.g., by detecting that the operating system boot loader has been loaded. In some examples the host device operating system loads a storage driver to the pre-boot storage driver. In some examples the controller 142 detect loading of the storage driver by detecting the receipt of a storage reset signal from the operating system within five seconds of detecting entry into a preboot mode.

At operation 525 the controller 142 reads the indirection table contents from the hiberfile. In some examples the BIOS loads the content of LBA 0 (i.e., the master boot record), which contains a piece of executable code (the OS boot strap) that loads the OS from the partition table. The OS boot strap loads the OS kernel module and the OS storage driver to read from the hiberfile. A typical indirection table representing the contents of a hiberfile is approximately 1 MB. Thus, it takes only a few milliseconds for the indirection table to the loaded and initialized in the memory device(s) 140. Further, in some examples the indirection table segments 314 which were marked for fast loading may be loaded into memory before other segments. The controller 142 may then process I/O requests directed to the fast load segments 314 while the remainder of the table is being loaded.

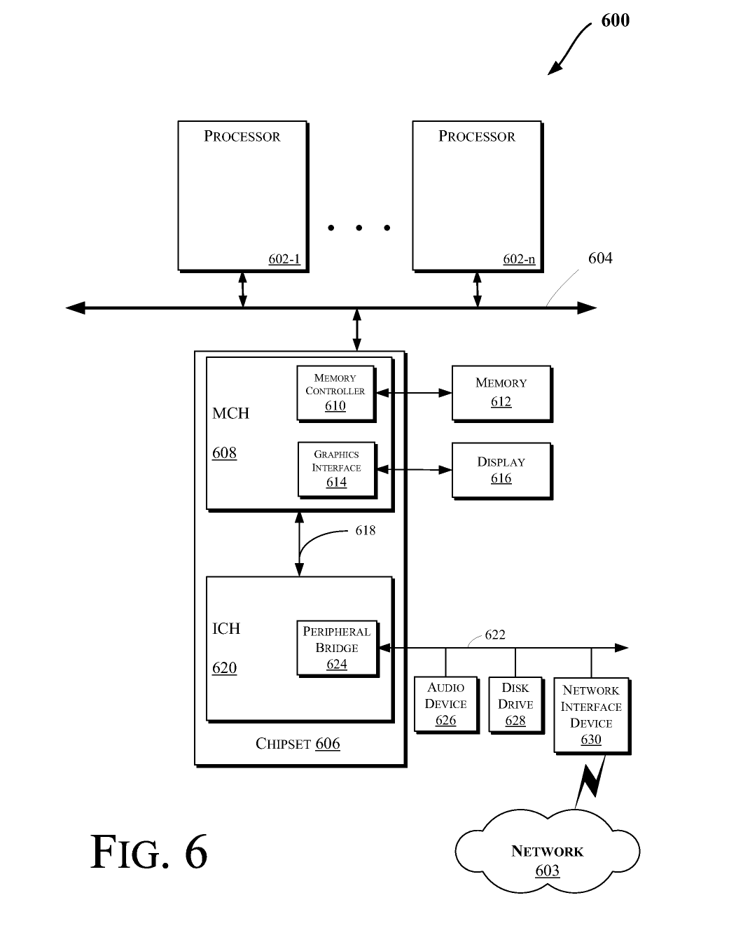

As described above, in some examples the electronic device may be embodied as a computer system. FIG. 6 illustrates a block diagram of a computing system 600 in accordance with an example. The computing system 600 may include one or more central processing unit(s) (CPUs) 602 or processors that communicate via an interconnection network (or bus) 604. The processors 602 may include a general purpose processor, a network processor (that processes data communicated over a computer network 603), or other types of a processor (including a reduced instruction set computer (RISC) processor or a complex instruction set computer (CISC)). Moreover, the processors 602 may have a single or multiple core design. The processors 602 with a multiple core design may integrate different types of processor cores on the same integrated circuit (IC) die. Also, the processors 602 with a multiple core design may be implemented as symmetrical or asymmetrical multiprocessors. In an example, one or more of the processors 602 may be the same or similar to the processors 102 of FIG. 1. For example, one or more of the processors 602 may include the control unit 120 discussed with reference to FIGS. 1-3. Also, the operations discussed with reference to FIGS. 3-5 may be performed by one or more components of the system 600.

A chipset 606 may also communicate with the interconnection network 604. The chipset 606 may include a memory control hub (MCH) 608. The MCH 608 may include a memory controller 610 that communicates with a memory 612 (which may be the same or similar to the memory 130 of FIG. 1). The memory 412 may store data, including sequences of instructions, that may be executed by the CPU 602, or any other device included in the computing system 600. In one example, the memory 612 may include one or more volatile storage (or memory) devices such as random access memory (RAM), dynamic RAM (DRAM), synchronous DRAM (SDRAM), static RAM (SRAM), or other types of storage devices. Nonvolatile memory may also be utilized such as a hard disk. Additional devices may communicate via the interconnection network 604, such as multiple CPUs and/or multiple system memories.

The MCH 608 may also include a graphics interface 614 that communicates with a display device 616. In one example, the graphics interface 614 may communicate with the display device 616 via an accelerated graphics port (AGP). In an example, the display 616 (such as a flat panel display) may communicate with the graphics interface 614 through, for example, a signal converter that translates a digital representation of an image stored in a storage device such as video memory or system memory into display signals that are interpreted and displayed by the display 616. The display signals produced by the display device may pass through various control devices before being interpreted by and subsequently displayed on the display 616.

A hub interface 618 may allow the MCH 608 and an input/output control hub (ICH) 620 to communicate. The ICH 620 may provide an interface to I/O device(s) that communicate with the computing system 600. The ICH 620 may communicate with a bus 622 through a peripheral bridge (or controller) 624, such as a peripheral component interconnect (PCI) bridge, a universal serial bus (USB) controller, or other types of peripheral bridges or controllers. The bridge 624 may provide a data path between the CPU 602 and peripheral devices. Other types of topologies may be utilized. Also, multiple buses may communicate with the ICH 620, e.g., through multiple bridges or controllers. Moreover, other peripherals in communication with the ICH 620 may include, in various examples, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or other devices.

The bus 622 may communicate with an audio device 626, one or more disk drive(s) 628, and a network interface device 630 (which is in communication with the computer network 603). Other devices may communicate via the bus 622. Also, various components (such as the network interface device 630) may communicate with the MCH 608 in some examples. In addition, the processor 602 and one or more other components discussed herein may be combined to form a single chip (e.g., to provide a System on Chip (SOC)). Furthermore, the graphics accelerator 616 may be included within the MCH 608 in other examples.

Furthermore, the computing system 600 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 628), a floppy disk, a compact disk ROM (CD-ROM), a digital versatile disk (DVD), flash memory, a magneto-optical disk, or other types of nonvolatile machine-readable media that are capable of storing electronic data (e.g., including instructions).

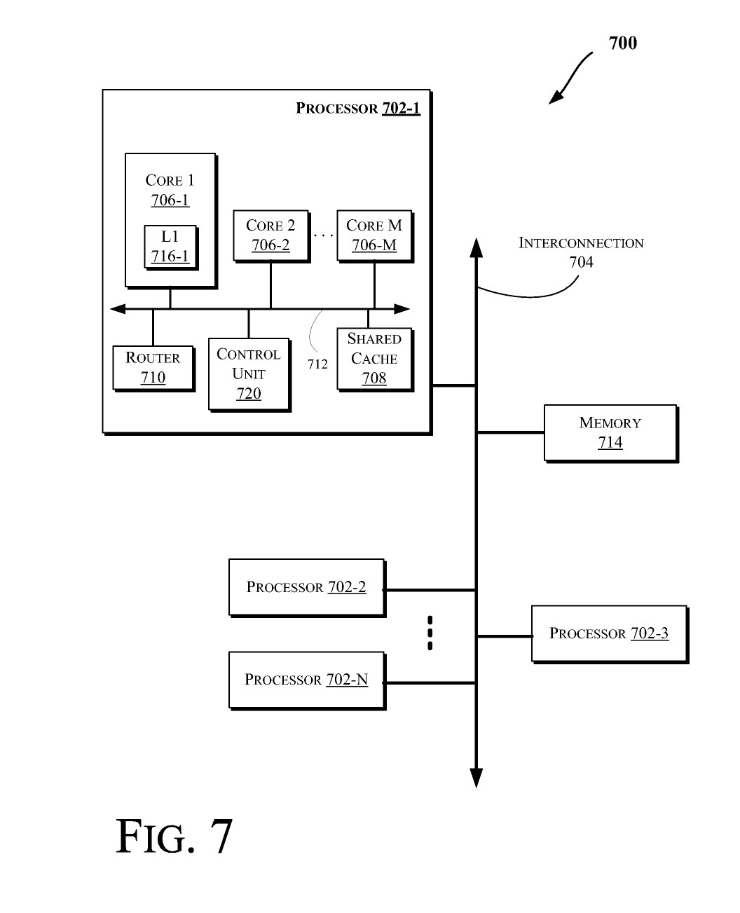

FIG. 7 illustrates a block diagram of a computing system 700, according to an example. The system 700 may include one or more processors 702-1 through 702-N (generally referred to herein as “processors 702” or “processor 702”). The processors 702 may communicate via an interconnection network or bus 704. Each processor may include various components some of which are only discussed with reference to processor 702-1 for clarity. Accordingly, each of the remaining processors 702-2 through 702-N may include the same or similar components discussed with reference to the processor 702-1.

In an example, the processor 702-1 may include one or more processor cores 706-1 through 706-M (referred to herein as “cores 706” or more generally as “core 706”), a shared cache 708, a router 710, and/or a processor control logic or unit 720. The processor cores 706 may be implemented on a single integrated circuit (IC) chip. Moreover, the chip may include one or more shared and/or private caches (such as cache 708), buses or interconnections (such as a bus or interconnection network 712), memory controllers, or other components.

In one example, the router 710 may be used to communicate between various components of the processor 702-1 and/or system 700. Moreover, the processor 702-1 may include more than one router 710. Furthermore, the multitude of routers 710 may be in communication to enable data routing between various components inside or outside of the processor 702-1.

The shared cache 708 may store data (e.g., including instructions) that are utilized by one or more components of the processor 702-1, such as the cores 706. For example, the shared cache 708 may locally cache data stored in a memory 714 for faster access by components of the processor 702. In an example, the cache 708 may include a mid-level cache (such as a level 2 (L2), a level 3 (L3), a level 4 (L4), or other levels of cache), a last level cache (LLC), and/or combinations thereof. Moreover, various components of the processor 702-1 may communicate with the shared cache 708 directly, through a bus (e.g., the bus 712), and/or a memory controller or hub. As shown in FIG. 7, in some examples, one or more of the cores 706 may include a level 1 (L1) cache 716-1 (generally referred to herein as “L1 cache 716”). In one example, the control unit 720 may include logic to implement the operations described above with reference to the memory controller 122 in FIG. 2.

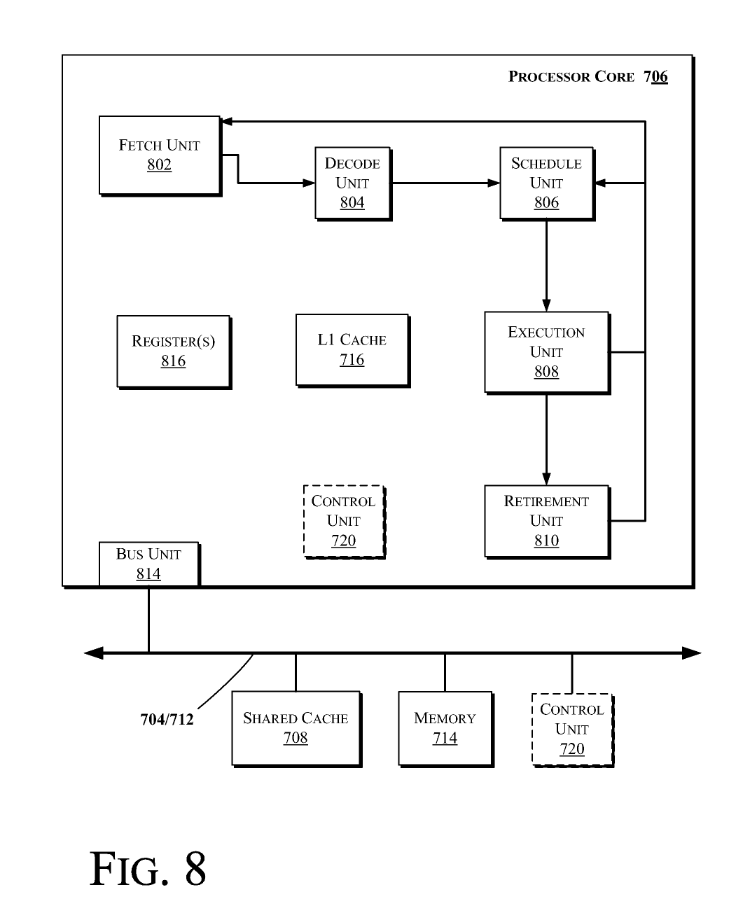

FIG. 8 illustrates a block diagram of portions of a processor core 706 and other components of a computing system, according to an example. In one example, the arrows shown in FIG. 8 illustrate the flow direction of instructions through the core 706. One or more processor cores (such as the processor core 706) may be implemented on a single integrated circuit chip (or die) such as discussed with reference to FIG. 7. Moreover, the chip may include one or more shared and/or private caches (e.g., cache 708 of FIG. 7), interconnections (e.g., interconnections 704 and/or 112 of FIG. 7), control units, memory controllers, or other components.

As illustrated in FIG. 8, the processor core 706 may include a fetch unit 802 to fetch instructions (including instructions with conditional branches) for execution by the core 706. The instructions may be fetched from any storage devices such as the memory 714. The core 706 may also include a decode unit 804 to decode the fetched instruction. For instance, the decode unit 804 may decode the fetched instruction into a plurality of uops (micro-operations).

Additionally, the core 706 may include a schedule unit 806. The schedule unit 806 may perform various operations associated with storing decoded instructions (e.g., received from the decode unit 804) until the instructions are ready for dispatch, e.g., until all source values of a decoded instruction become available. In one example, the schedule unit 806 may schedule and/or issue (or dispatch) decoded instructions to an execution unit 808 for execution. The execution unit 808 may execute the dispatched instructions after they are decoded (e.g., by the decode unit 804) and dispatched (e.g., by the schedule unit 806). In an example, the execution unit 808 may include more than one execution unit. The execution unit 808 may also perform various arithmetic operations such as addition, subtraction, multiplication, and/or division, and may include one or more an arithmetic logic units (ALUs). In an example, a co-processor (not shown) may perform various arithmetic operations in conjunction with the execution unit 808.

Further, the execution unit 808 may execute instructions out-of-order. Hence, the processor core 706 may be an out-of-order processor core in one example. The core 706 may also include a retirement unit 810. The retirement unit 810 may retire executed instructions after they are committed. In an example, retirement of the executed instructions may result in processor state being committed from the execution of the instructions, physical registers used by the instructions being de-allocated, etc.

The core 706 may also include a bus unit 714 to enable communication between components of the processor core 706 and other components (such as the components discussed with reference to FIG. 8) via one or more buses (e.g., buses 804 and/or 812). The core 706 may also include one or more registers 816 to store data accessed by various components of the core 706 (such as values related to power consumption state settings).

Furthermore, even though FIG. 7 illustrates the control unit 720 to be coupled to the core 706 via interconnect 812, in various examples the control unit 720 may be located elsewhere such as inside the core 706, coupled to the core via bus 704, etc.

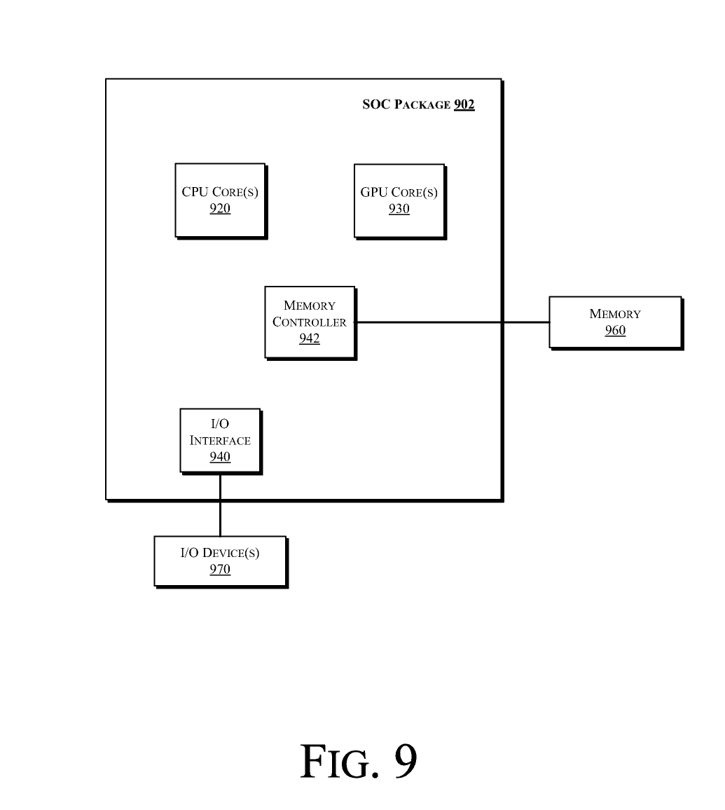

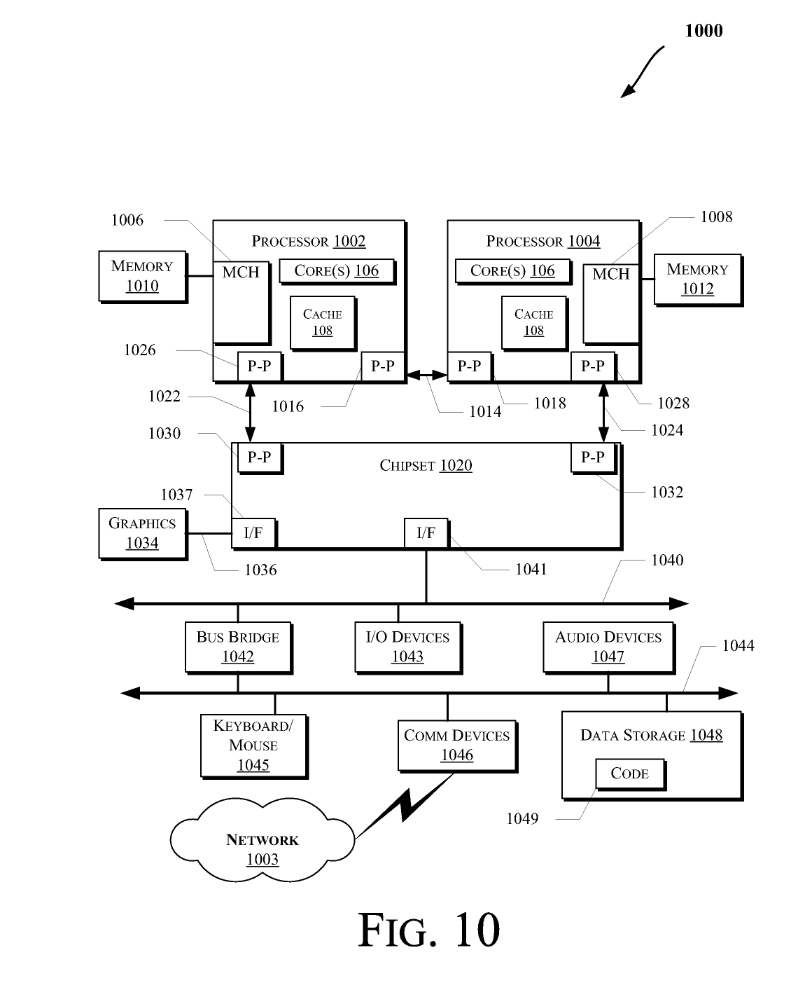

In some examples, one or more of the components discussed herein can be embodied as a System On Chip (SOC) device. FIG. 9 illustrates a block diagram of an SOC package in accordance with an example. As illustrated in FIG. 9, SOC 902 includes one or more Central Processing Unit (CPU) cores 920, one or more Graphics Processor Unit (GPU) cores 930, an Input/Output (I/O) interface 940, and a memory controller 942. Various components of the SOC package 902 may be coupled to an interconnect or bus such as discussed herein with reference to the other figures. Also, the SOC package 902 may include more or less components, such as those discussed herein with reference to the other figures. Further, each component of the SOC package 902 may include one or more other components, e.g., as discussed with reference to the other figures herein. In one example, SOC package 902 (and its components) is provided on one or more Integrated Circuit (IC) die, e.g., which are packaged into a single semiconductor device.

As illustrated in FIG. 9, SOC package 902 is coupled to a memory 960 (which may be similar to or the same as memory discussed herein with reference to the other figures) via the memory controller 942. In an example, the memory 960 (or a portion of it) can be integrated on the SOC package 902.

The I/O interface 940 may be coupled to one or more I/O devices 970, e.g., via an interconnect and/or bus such as discussed herein with reference to other figures. I/O device(s) 970 may include one or more of a keyboard, a mouse, a touchpad, a display, an image/video capture device (such as a camera or camcorder/video recorder), a touch screen, a speaker, or the like.

FIG. 10 illustrates a computing system 1000 that is arranged in a point-to-point (PtP) configuration, according to an example. In particular, FIG. 10 shows a system where processors, memory, and input/output devices are interconnected by a number of point-to-point interfaces. The operations discussed with reference to FIG. 2 may be performed by one or more components of the system 1000.

As illustrated in FIG. 10, the system 1000 may include several processors, of which only two, processors 1002 and 1004 are shown for clarity. The processors 1002 and 1004 may each include a local memory controller hub (MCH) 1006 and 1008 to enable communication with memories 1010 and 1012. MCH 1006 and 1008 may include the memory controller 120 and/or logic of FIG. 1 in some examples.

In an example, the processors 1002 and 1004 may be one of the processors 702 discussed with reference to FIG. 7. The processors 1002 and 1004 may exchange data via a point-to-point (PtP) interface 1014 using PtP interface circuits 1016 and 1018, respectively. Also, the processors 1002 and 1004 may each exchange data with a chipset 1020 via individual PtP interfaces 1022 and 1024 using point-to-point interface circuits 1026, 1028, 1030, and 1032. The chipset 1020 may further exchange data with a high-performance graphics circuit 1034 via a high-performance graphics interface 1036, e.g., using a PtP interface circuit 1037.

As shown in FIG. 10, one or more of the cores 106 and/or cache 108 of FIG. 1 may be located within the processors 1002 and 1004. Other examples, however, may exist in other circuits, logic units, or devices within the system 1000 of FIG. 10. Furthermore, other examples may be distributed throughout several circuits, logic units, or devices illustrated in FIG. 10.

The chipset 1020 may communicate with a bus 1040 using a point-to-point PtP interface circuit 1041. The bus 1040 may have one or more devices that communicate with it, such as a bus bridge 1042 and I/O devices 1043. Via a bus 1044, the bus bridge 1043 may communicate with other devices such as a keyboard/mouse 1045, communication devices 1046 (such as modems, network interface devices, or other communication devices that may communicate with the computer network 803), audio I/O device, and/or a data storage device 1048. The data storage device 1048 (which may be a hard disk drive or a NAND flash based solid state drive) may store code 1049 that may be executed by the processors 1002 and/or 1004.

The following pertains to further examples.

Example 1 is an electronic device comprising at least one processor, at least one storage device comprising a nonvolatile memory, and a controller coupled to the memory and comprising logic, at least partially including hardware logic, to receive a shutdown notification from a host device operating system, monitor modifications to one or more indirection table segments for the nonvolatile memory during a shutdown process, and mark the one or more indirection table segments which were modified during the shutdown for fast loading during a subsequent boot process for the electronic device.

In Example 2, the subject matter of Example 1 can optionally include logic, at least partially including hardware logic, to save the indirection table segments to a file to be stored in persistent memory.

In Example 3, the subject matter of any one of Examples 1-2 can optionally include an arrangement wherein the controller comprises logic, at least partially including hardware logic, to detect when the electronic device enters a preboot mode and in response to the electronic device entering the preboot mode, to allow read operations to at least one predetermined logical block address while the indirection table is being initialized.

In Example 4, the subject matter of any one of Examples 1-3 can optionally an arrangement in which the predetermined logical block address comprises logical block 0 through logical block 63.

In Example 5, the subject matter of any one of Examples 1-4 can optionally include logic at least partially including hardware logic, to detect when the electronic device enters a boot sequence and in response to the electronic device entering the boot sequence, to load one or more indirection table segments which were marked during the shutdown for fast loading during a subsequent boot process for the electronic device.

In Example 6, the subject matter of any one of Examples 1-5 can optionally include logic, at least partially including hardware logic, to process one or more input/output (I/O) operations while the indirection table segments are being read from the file stored in persistent memory.

Example 7 is a storage device comprising a nonvolatile memory, and a controller coupled to the memory and comprising logic, at least partially including hardware logic, to receive a shutdown notification from a host device operating system, monitor modifications to one or more indirection table segments for the nonvolatile memory during a shutdown process, and mark the one or more indirection table segments which were modified during the shutdown for fast loading during a subsequent boot process for the electronic device.

In Example 8, the subject matter of Example 7 can optionally include logic, at least partially including hardware logic, to save the indirection table segments to a file to be stored in persistent memory.

In Example 9, the subject matter of any one of Examples 7-8 can optionally include an arrangement wherein the controller comprises logic, at least partially including hardware logic, to detect when the electronic device enters a preboot mode and in response to the electronic device entering the preboot mode, to allow read operations to at least one predetermined logical block address while the indirection table is being initialized.

In Example 10, the subject matter of any one of Examples 7-9 can optionally an arrangement in which the predetermined logical block address comprises logical block 0 through logical block 63.

In Example 11, the subject matter of any one of Examples 7-10 can optionally include logic at least partially including hardware logic, to detect when the electronic device enters a boot sequence and in response to the electronic device entering the boot sequence, to load one or more indirection table segments which were marked during the shutdown for fast loading during a subsequent boot process for the electronic device.

In Example 12, the subject matter of any one of Examples 7-11 can optionally include logic, at least partially including hardware logic, to process one or more input/output (I/O) operations while the indirection table segments are being read from the file stored in persistent memory.

Example 13 is a controller coupled to the memory and comprising logic, at least partially including hardware logic, to receive a shutdown notification from a host device operating system, monitor modifications to one or more indirection table segments for the nonvolatile memory during a shutdown process, and mark the one or more indirection table segments which were modified during the shutdown for fast loading during a subsequent boot process for the electronic device.

In Example 14, the subject matter of Example 13 can optionally include logic, at least partially including hardware logic, to save the indirection table segments to a file to be stored in persistent memory.

In Example 15, the subject matter of any one of Examples 13-14 can optionally include an arrangement wherein the controller comprises logic, at least partially including hardware logic, to detect when the electronic device enters a preboot mode and in response to the electronic device entering the preboot mode, to allow read operations to at least one predetermined logical block address while the indirection table is being initialized.

In Example 16, the subject matter of any one of Examples 13-15 can optionally an arrangement in which the predetermined logical block address comprises logical block 0 through logical block 63.

In Example 17, the subject matter of any one of Examples 13-16 can optionally include logic at least partially including hardware logic, to detect when the electronic device enters a boot sequence and in response to the electronic device entering the boot sequence, to load one or more indirection table segments which were marked during the shutdown for fast loading during a subsequent boot process for the electronic device.

In Example 18, the subject matter of any one of Examples 13-517 can optionally include logic, at least partially including hardware logic, to process one or more input/output (I/O) operations while the indirection table segments are being read from the file stored in persistent memory.

Example 19 is processor-based method to manage boot operations in storage devices, comprising receiving, in a processor, a shutdown notification from a host device operating system, monitoring modifications to one or more indirection table segments for the nonvolatile memory during a shutdown process, and marking the one or more indirection table segments which were modified during the shutdown for fast loading during a subsequent boot process for the electronic device.

In Example 20, the subject matter of Example 19 can optionally include saving the indirection table segments to a file to be stored in persistent memory.

In Example 21, the subject matter of any one of Examples 19-20 can optionally detecting when the electronic device enters a preboot mode and in response to the electronic device entering the preboot mode, allowing read operations to at least one predetermined logical block address while the indirection table is being initialized.

In Example 22, the subject matter of any one of Examples 19-21 can optionally an arrangement in which the predetermined logical block address comprises logical block 0 through logical block 63.

In Example 23, the subject matter of any one of Examples 19-22 can optionally include detecting when the electronic device enters a boot sequence and in response to the electronic device entering the boot sequence, loading one or more indirection table segments which were marked during the shutdown for fast loading during a subsequent boot process for the electronic device.

In Example 24, the subject matter of any one of Examples 19-23 can optionally include processing one or more input/output (I/O) operations while the indirection table segments are being read from the file stored in persistent memory.

In various examples, the operations discussed herein, e.g., with reference to FIGS. 1-10, may be implemented as hardware (e.g., circuitry), software, firmware, microcode, or combinations thereof, which may be provided as a computer program product, e.g., including a tangible (e.g., non-transitory) machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed herein.

Reference in the specification to “one example” or “an example” means that a particular feature, structure, or characteristic described in connection with the example may be included in at least an implementation. The appearances of the phrase “in one example” in various places in the specification may or may not be all referring to the same example.

Also, in the description and claims, the terms “coupled” and “connected,” along with their derivatives, may be used. In some examples, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although examples have been described in language specific to structural features and/or methodological acts, it is to be understood that claimed subject matter may not be limited to the specific features or acts described. Rather, the specific features and acts are disclosed as sample forms of implementing the claimed subject matter.

1. An electronic device, comprising:
at least one processor; and
at least one storage device comprising a nonvolatile memory; and
a controller coupled to the memory and comprising logic, at least partially including hardware logic, to:
receive a shutdown notification from a host device operating system;
monitor modifications to one or more indirection table segments for the nonvolatile memory during a shutdown process; and
mark the one or more indirection table segments which were modified during the shutdown for fast loading during a subsequent boot process for the electronic device.

2. The electronic device of claim 1, further comprising logic, at least partially including hardware logic, to:
save the indirection table segments to a file to be stored in persistent memory.

3. The electronic device of claim 2, wherein the controller comprises logic, at least partially including hardware logic, to:
detect when the electronic device enters a preboot mode; and
in response to the electronic device entering the preboot mode, to allow read operations to at least one predetermined logical block address while the indirection table is being initialized.

4. The electronic device of claim 3, wherein the predetermined logical block address comprises logical block 0 through logical block 63.

5. The electronic device of claim 2, wherein the controller comprises logic, at least partially including hardware logic, to:
detect when the electronic device enters a boot sequence; and
in response to the electronic device entering the boot sequence, to load one or more indirection table segments which were marked during the shutdown for fast loading during a subsequent boot process for the electronic device.

6. The electronic device of claim 5, wherein the controller comprises logic, at least partially including hardware logic, to:
process one or more input/output (I/O) operations while the indirection table segments are being read from the file stored in persistent memory.

7. A storage device, comprising:
a nonvolatile memory; and
a controller coupled to the memory and comprising logic, at least partially including hardware logic, to:
receive a shutdown notification from a host device operating system;
monitor modifications to one or more indirection table segments for the nonvolatile memory during a shutdown process; and
mark the one or more indirection table segments which were modified during the shutdown for fast loading during a subsequent boot process for the host device.

8. The storage device of claim 7, further comprising logic, at least partially including hardware logic, to:
save the indirection table segments to a file to be stored in persistent memory.

9. The storage device of claim 8, wherein the controller comprises logic, at least partially including hardware logic, to:
detect when the host device enters a preboot mode; and
in response to the host device entering the preboot mode, to allow read operations to at least one predetermined logical block address while the indirection table is being initialized.

10. The storage device of claim 9, wherein the predetermined logical block address comprises logical block 0 through logical block 63.

11. The storage device of claim 8, wherein the controller comprises logic, at least partially including hardware logic, to:
detect when the electronic device enters a boot sequence; and
in response to the electronic device entering the boot sequence, to load one or more indirection table segments which were marked during the shutdown for fast loading during a subsequent boot process for the electronic device.

12. The storage device of claim 11, wherein the controller comprises logic, at least partially including hardware logic, to:
process one or more input/output (I/O) operations while the indirection table segments are being read from the file stored in persistent memory.

13. A controller comprising logic, at least partially including hardware logic, to:
receive a shutdown notification from a host device operating system;
monitor modifications to one or more indirection table segments for the nonvolatile memory during a shutdown process; and
mark the one or more indirection table segments which were modified during the shutdown for fast loading during a subsequent boot process for the host device.

14. The controller of claim 13, further comprising logic, at least partially including hardware logic, to:
save the indirection table segments to a file to be stored in persistent memory.

15. The controller of claim 14, wherein the controller comprises logic, at least partially including hardware logic, to:
detect when the host device enters a preboot mode; and
in response to the host device entering the preboot mode, to allow read operations to at least one predetermined logical block address while the indirection table is being initialized.

16. The controller of claim 15, wherein the predetermined logical block address comprises logical block 0 through logical block 63.

17. The controller of claim 14, wherein the controller comprises logic, at least partially including hardware logic, to:
detect when the host device enters a boot sequence; and
in response to the host device entering the boot sequence, to load one or more indirection table segments which were marked during the shutdown for fast loading during a subsequent boot process for the electronic device.

18. The controller of claim 17, wherein the controller comprises logic, at least partially including hardware logic, to:
process one or more input/output (I/O) operations while the indirection table segments are being read from the file stored in persistent memory.

19. A processor-based method to manage boot operations in storage devices, comprising:
receiving, in a processor, a shutdown notification from a host device operating system;
monitoring modifications to one or more indirection table segments for the nonvolatile memory during a shutdown process; and
marking the one or more indirection table segments which were modified during the shutdown for fast loading during a subsequent boot process for the electronic device.

20. The method of claim 19, further comprising:
saving the indirection table segments to a file to be stored in persistent memory.

21. The method of claim 20, further comprising:
detecting when the electronic device enters a preboot mode; and
in response to the electronic device entering the preboot mode, allowing read operations to at least one predetermined logical block address while the indirection table is being initialized.

22. The method of claim 21, wherein the predetermined logical block address comprises logical block 0 through logical block 63.

23. The method of claim 20, further comprising:
detecting when the electronic device enters a boot sequence; and
in response to the electronic device entering the boot sequence, to loading or more indirection table segments which were marked during the shutdown for fast loading during a subsequent boot process for the electronic device.

24. The method of claim 23, further comprising:
processing one or more input/output (I/O) operations while the indirection table segments are being read from the file stored in persistent memory.
